(19) United States
(12) Patent Application Publication
(10) Pub. No.: US 2025/0230042 A1
(43) Pub. Date: Jul. 17, 2025

(54) SOLAR-DRIVEN PRODUCTION OF HYDROGEN

(71) Applicant: Saudi Arabian Oil Company, Dhahran (SA)

(72) Inventors: Sehmus Ozden, Katy, TX (US); Huseyin Rahmi Seren, Katy, TX (US); Fakuen Frank Chang, Houston, TX (US); Feng Liang, Houston, TX (US)

(21) Appl. No.: 18/415,244

(22) Filed: Jan. 17, 2024

(51) Int. Cl. C01B 3/26; B01J 6/00; B01J 19/24; C09C 1/48; F24S 23/30; F24S 23/71; F24S 30/425; F24S 70/225

(52) U.S. Cl. CPC C01B 3/26; B01J 6/008; B01J 19/242; C09C 1/48; F24S 23/31; F24S 23/71; F24S 30/425; F24S 70/225; C01B 2203/0277; C01B 2203/049; C01B 2203/0805; C01B 2203/1047; C01B 2203/1058; C01B 2203/1064; C01B 2203/1082; C01B 2203/1241; C01B 2203/127

(57) ABSTRACT

A system and method for production of hydrogen from natural gas using a solar powered system are provided. An exemplary solar powered system includes a feed stream including methane and a solar concentrator reactor (SCR) to form hydrogen from the feed stream by pyrolysis. The SCR includes a rotating tubular reactor, a solar absorber material disposed on the rotating tubular reactor, a solar concentrator to focus sunlight on the rotating tubular reactor, and a gas-solid filtration unit to separate solid carbon from the hydrogen. The solar powered system includes a storage tank to hold the hydrogen.

### TECHNICAL FIELD

This disclosure relates to methods of producing hydrogen through the pyrolysis of methane in a solar reactor.

### BACKGROUND

Hydrogen (H₂) is a promising alternative energy source to fossil fuels for clean and sustainable energy demand. Hydrogen can be produced using a number of technologies, termed white hydrogen, green hydrogen, or blue hydrogen, depending on the source. White hydrogen is produced from in-ground reservoirs. Green hydrogen is produced using renewable energy to power the process. Blue hydrogen is produced using standard industrial techniques, such as steam methane reforming (SMR), autothermal methane reforming (ATR), and partial oxidation of methane (POM). However, the industrial methods for producing hydrogen are high temperature processes that need a large amount of energy input.

For example, in the SMR process, methane reacts with steam at high temperatures, such as about 700° C. to about 1,000° C., under a high-pressure of about 3 bar to about 25 bar. This produces syngas, which is a mixture that primarily includes H₂ and CO, with a small amount of CO₂. The syngas is further processed in a water-gas shift (WGS) reaction to convert CO to CO₂ and generate additional hydrogen. Depending on the purity requirements for the hydrogen, a pressure-swing adsorption process is often used to remove carbon dioxide and other impurities.

Steam reforming is endothermic and requires heat to be supplied. While the water-gas shift (WGS) reaction is an exothermic reaction, the process can lead to excessive CO₂ generation as a hydrogen-rich gas is produced. The combination of the steam methane reforming reaction and the water gas shift reaction can be described by the following equations:

CH₄+H₂O→CO+3H₂ΔH₂₉₈206 kJ mol⁻¹

CO+H₂O→CO₂+H₂ΔH₂₉₈−41 kJ mol⁻¹

The overall hydrogen production process by SMR, and other commercial processes, consume a large amount of power which comes from burning fossil fuels directly or from the electric power that is mostly produced by fossil fuels, generating blue hydrogen. Further, the CO₂ that is generated in the process and when supplying the required energy negates the purpose of having a sustainable clean energy.

### SUMMARY

An embodiment described herein provides a solar powered system for production of hydrogen from natural gas. The solar powered system includes a feed stream including methane and a solar concentrator reactor (SCR) to form hydrogen from the feed stream by pyrolysis. The SCR includes a rotating tubular reactor, a solar absorber material disposed on the rotating tubular reactor, a solar concentrator to focus sunlight on the rotating tubular reactor, and a gas-solid filtration unit to separate solid carbon from the hydrogen. The solar powered system includes a storage tank to hold the hydrogen.

Another embodiment described herein provides a method of producing hydrogen in a solar concentrator reactor. The method includes desulfurizing a raw natural gas stream to form a desulfurized stream, feeding the desulfurized stream to a solar concentrator reactor. The solar concentrator reactor includes a rotating tubular reactor, a solar absorber material disposed on the rotating tubular reactor, a solar concentrator to focus sunlight on the rotating tubular reactor, and a gas-solid filtration unit to separate solid carbon from the hydrogen. The method includes pyrolyzing the desulfurized stream to form a gaseous effluent including hydrogen and entrained solid carbon particles, separating solids from the hydrogen, and providing the hydrogen as a product stream.

### BRIEF DESCRIPTION OF DRAWINGS

FIG. 1 is a block diagram of a system for producing hydrogen from a raw natural gas in a pyrolysis reaction using a solar concentrator reactor (SCR).

FIG. 2 is a schematic drawing of a parabolic-trough SCR for hydrogen production.

FIG. 3 is a side cross-sectional view of the parabolic-trough SCR.

FIG. 4 is a schematic drawing of a linear mirror SCR for hydrogen production.

FIG. 5 is a schematic drawing of a parabolic SCR with a vertically aligned rotating tubular reactor.

FIG. 6 is a schematic drawing of a linear mirror SCR that is placed in a vertical configuration.

FIG. 7 is a schematic drawing of an optical concentrator SCR for hydrogen production.

FIG. 8 is a block flow diagram of a method for producing hydrogen from a natural gas stream using solar energy.

### DETAILED DESCRIPTION

Techniques for producing substantially green hydrogen using pyrolysis, and other techniques, is disclosed herein. As used herein, substantially green hydrogen indicates that the heat for the process is directly provided by renewable solar energy using a solar concentrator reactor. This lowers the amount of CO₂ is generated from energy supply processes. Accordingly, the only green-house gases (GHG) include the CO₂ produced in the hydrogen generation reactions and a small amount generated during power production for ancillary processes, such as operating compressors, pumps, valves, and the like. This may be further mitigated by powering the ancillary processes using renewable energy.

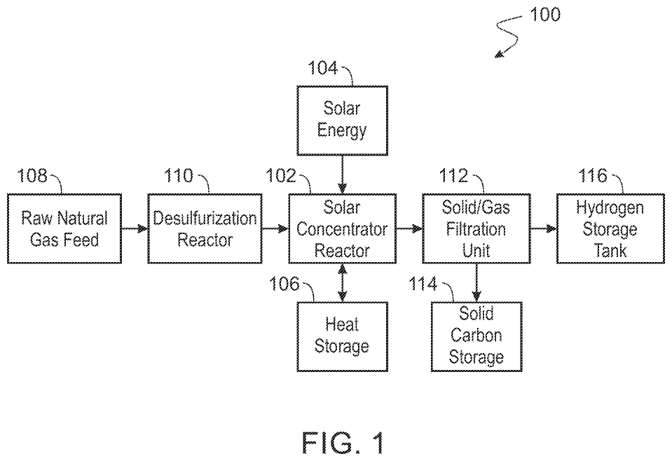

FIG. 1 is a block diagram of a system 100 for producing hydrogen from a raw natural gas in a pyrolysis reaction using a solar concentrator reactor (SCR) 102. Although pyrolysis is described in examples herein, the SCR 102 can be integrated into various H₂ production systems, including SMR, ATR, and POM, among others.

As described, current hydrogen production methods are highly endothermic processes that require a large energy input, such as for preheating feedstock, and cracking CH₄ bonds in pyrolysis. The SCR 102 uses high temperature, concentrated solar energy 104 to provide heat energy to the reaction. In addition to lowering CO₂ generated in power plants, it also limits inefficiencies from generating heat from electrical energy produced from renewable resources.

For operations during the night, a backup energy source such as a power grid or furnace, may to provide the energy. Further, heat energy can be stored in a heat storage system 106, utilizing thermal mass, such as molten salts or steam, for use during dark hours.

In some embodiments, a raw natural gas feed 108 is fed to a desulfurization reactor 110, which removes H2S and other sulfur compounds from the natural gas. The desulfurization reactor 110 can be a hydrodesulfurization system using a hydrogen feed and a hydrodesulfurization catalyst to remove the sulfur.

In various embodiments, the SCR 102 is formed from a rotating tubular reactor comprising a solar absorber material disposed on the outer surface of the rotating tubular reactor and a solar concentrator to focus sunlight on the rotating tubular reactor. The effluent from the SCR 102 is passed to a solid gas filtration unit 112, which separates entrained solid carbon particles formed during the pyrolysis process from a gaseous effluent, primarily including hydrogen. In various embodiments, the solid gas filtration unit 112 includes filters, cyclonic separators, and other filtration technologies.

The solid carbon particles can include carbon black and carbon nanotubes, among others. The separated solid carbon particles are fed to a solid carbon storage vessel 114. The solid carbon particles can be sold as a product, further increasing the economic benefit of the technique.

The hydrogen from the gaseous effluent is passed to a hydrogen storage tank 116. Depending on the purity requirements, the hydrogen can be further purified, for example, by a hydrogen selective membrane. In some embodiments, a portion of the hydrogen is used in the desulfurization reactor 110.

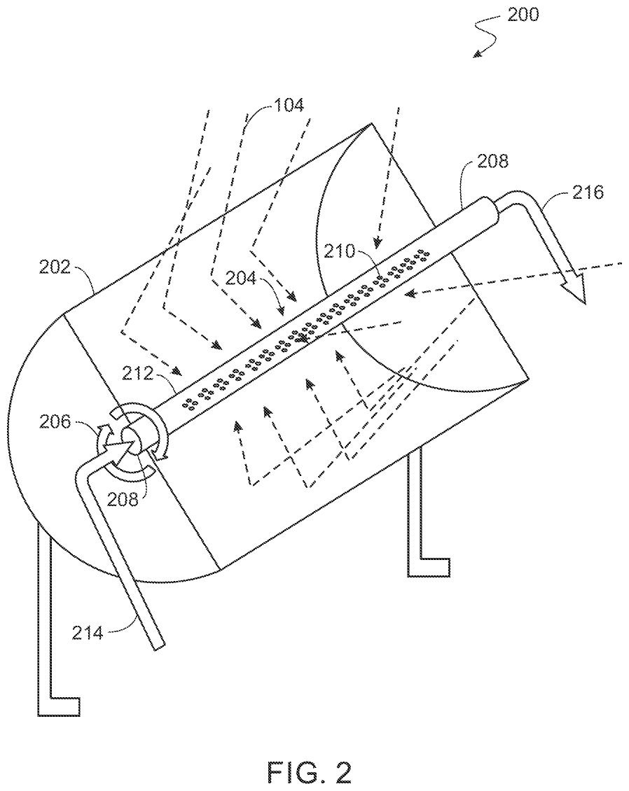

FIG. 2 is a schematic drawing of a parabolic-trough SCR 200 for hydrogen production. Like numbered items are as described with respect to FIG. 1. The parabolic-trough SCR 200 includes a parabolic reflector 202 that focuses solar energy 104 on a rotating tubular reactor 204, which is placed at the focal point. The parabolic reflector 202 is rotated to face the sun, directing the solar energy 104 on the rotating tubular reactor 204.

The rotation 206 of the rotating tubular reactor 204 helps to decrease fouling due to temperature differentials. A gas seal 208 at each end of the rotating tubular reactor 204 maintains the pressure in the rotating tubular reactor 204 during the process. The rotating tubular reactor 204 includes a catalyst 210 disposed inside the rotating tubular reactor 204. The concentrated solar heat facilitates the pyrolysis of methane into H₂ and solid carbon above 300° C. in the presence of the catalyst 210.

In various embodiments, the catalyst 210 includes nickel, iron, palladium, or molybdenum, or a combination thereof. The catalyst 210 can be supported on a catalyst support that includes Al₂O₃, Al₂O₄, SiO₂, MgO, TiO₂, Fe₂O₄, FeO, ZrO₂, CeO₂, Er₂O₃, or a lanthanide oxide, or any combination thereof.

In various embodiments, the rotating tubular reactor 204 is a stainless-steel reactor, or another reactor material that has a high heat conductivity and resists corrosion at high temperatures, such as a heat conductive ceramic. For example, the rotating tubular reactor 204 can be made from aluminum nitride, boron nitride, or a combination thereof, among others.

In some embodiments, rotating tubular reactor 204 has a two-layer coating 212, wherein an outer layer is substantially transparent to light, for example, in a wavelength range of about 250 nm to about 1500 nm. The outer layer can be formed from glass, sapphire, or diamond, or a combination thereof. The outer layer can be a thin film, for example, with a thickness of about 0.5 mm to about 1 mm, or can be a thicker layer, for example, with a thickness of up to about 5 cm, about 2 cm, or about 1 cm.

An inner layer, disposed under the outer layer, and in contact with the rotating tubular reactor 204, is substantially opaque to light in a wavelength range of about 250 nm to about 1500 nm, absorbing the light to convert it to heat energy. The inner layer may be a solid film, for example, formed from carbon black, silicon carbide, or a combination thereof, among others. The solid film can have a thickness between about 200 nm to about 10 μm.

In some embodiments, the inner layer includes a dielectric meta-material, such as silicon carbide particles. Silicon carbide particles have a high permeability at visible and infrared wavelengths, allowing them to function as a meta-material. The size distribution of the silicon carbide particles is selected to maximize the absorbency of light, for example, with particles in a size range of about 10 nm to about 200 nm, can function as a dielectric meta-material due to the high permeability at visible and infrared wavelengths. The inner layer can include a substrate to support the silicon carbide particles, such as tungsten, to increase the absorption.

In some embodiments, the inner layer is a plasmonic based metal insulator metal (M-I-M) based metamaterial absorber. In this design, a metal reactor, such as steel, can serve as the main substrate. A thin layer of dielectric material, for example, less than about 1 μm, including silicon nitride, silicon oxide, or any other material that is transparent in the desired wavelength range is placed on the substrate. Metal particles with sizes of between about 10 nm and about 500 nm, depending on the wavelength range, are placed on top of the dielectric layer. The metal particles can be made of a material that has a plasmonic nature in the desired wavelength range, such as Au, Ag, Al, Cu, W, Ti, or Cr, among others. The plasmonic particles can also include highly doped semiconductors, such as Si, GaAs, InAs, InSb, and the like.

The layer thicknesses, particle sizes, and particle shapes can be selected based on full-wave electromagnetic simulations that incorporate the complex permittivity of each material used to create the metamaterials. For example, the particles can be disks, hemispheres, rods, crosses, split ring resonators, or combinations of these particles, or more complex shapes. The particles can be printed in patterns on the surface of the rotating tubular reactor 204, for example, using ink-jet printing, transfer printing, and the like.

In the process, a feedstock stream 214 that includes methane and, in some embodiments, an inert gas as a carrier gas, is introduced into the rotating tubular reactor 204. The flow velocity through the reactor can range from about 5 sccm to about 1000 sccm, or about 10 sccm to about 500 sccm, or about 50 sccm to about 100 sccm. The flow velocity may be determined by the productivity of the catalyst, temperature of the reactor, and the amount of insolation (solar flux). The temperature of the rotating tubular reactor 204, located at the focal point of the parabolic reflector 202, can be between about 300° C. to about 1200° C., or between about 500° C. and about 1000° C., or between about 700° C. at about 800° C., depending on the insolation.

The effluent gas 216 from the rotating tubular reactor 204 will include H₂ gas and entrained solid carbon particles formed by rapid thermal cracking of methane with the existing catalysts located in the reactors bed. The process can achieve between about 20% to about 99.9% efficiency in conversion of the methane into H₂ and the solid carbon. In some embodiments, a portion of the effluent gas 216 can be recycled to the rotating tubular reactor 204 to increase the yield. This may be performed, for example, when lower insolation leads to lower temperatures in the rotating tubular reactor 204.

In some embodiments, the feedstock stream 214 is preheated by solar heat before entering the reaction section of the rotating tubular reactor 204, e.g., coming into contact with the catalyst 210. The pyrolysis reaction is endothermic and is sustained by the concentrated solar heat from the focused parabolic reflector 202.

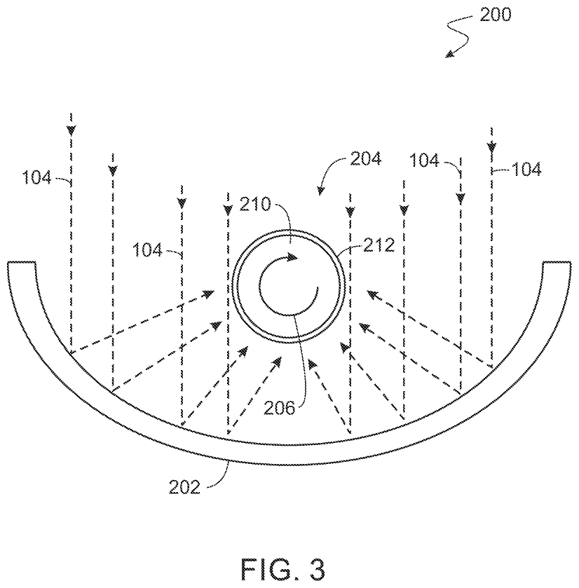

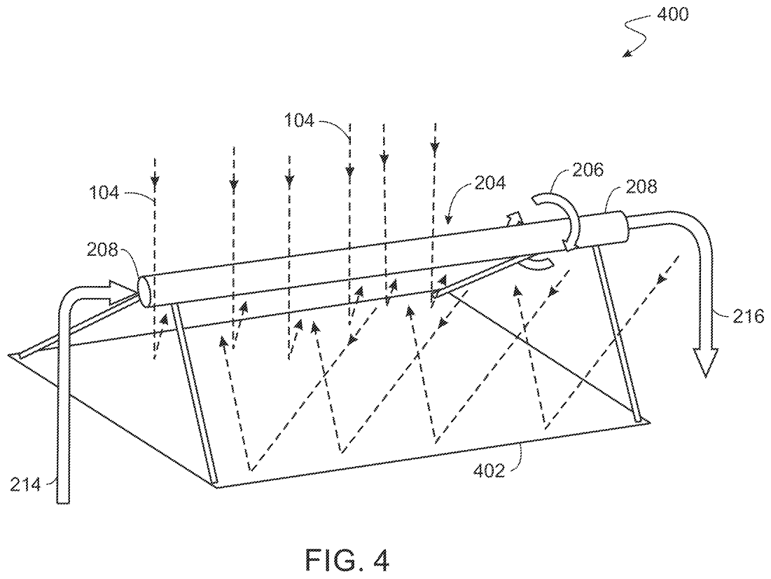

FIG. 3 is a side cross-sectional view of the parabolic-trough SCR 200. Like numbered items are as described with respect to FIGS. 1 and 2. The side cross-sectional view illustrates the location of the rotating tubular reactor 204 at the focal point of the parabolic reflector 202. Any number of designs may be used for the solar concentrator as described further with respect to FIGS. 4-7.

FIG. 4 is a schematic drawing of a linear mirror SCR 400 for hydrogen production. Like numbered items are as described with respect to FIGS. 1 and 2. The linear mirror SCR 400 uses linear mirrors 402 to capture the solar energy, which reflect and focus the sunlight onto the rotating tubular reactor 204. The linear mirrors 402 can include a number of solar mirrors in parallel rows that are oriented in a north-south positioning and track the sun from east to west during the day. This ensures that the solar energy is reflects continuously onto the reactor.

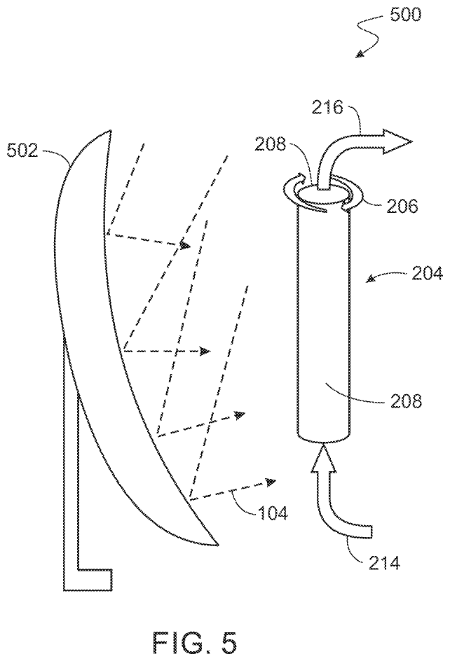

FIG. 5 is a schematic drawing of a parabolic SCR 500 with a vertically aligned rotating tubular reactor 204. Like numbered items are as described with respect to FIGS. 1 and 2. In this example, a parabolic reflector 502 focuses the solar energy on a vertically aligned rotating tubular reactor 204. The parabolic reflector 502 may be a parabolic-trough reflector similar to that described with respect to FIG. 2 but placed on a vertical axis. In other embodiments, the parabolic reflector 502 may be a dish type reflector with the rotating tubular reactor 204 located at the focal point. In this case, a higher temperature may be possible as the reflecting surface area may be higher than in FIG. 2.

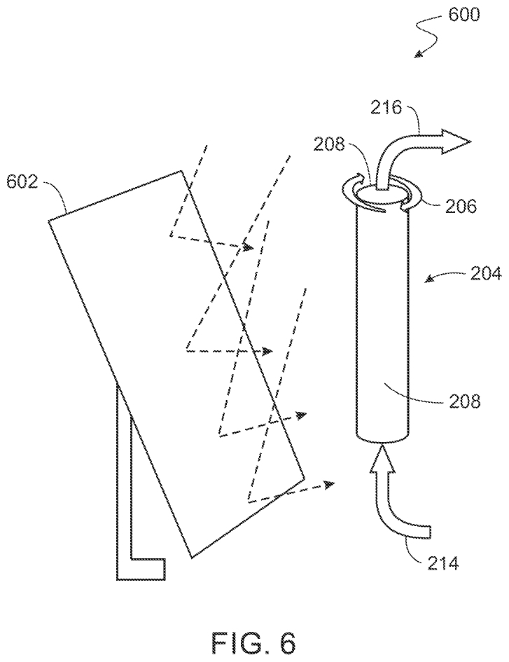

FIG. 6 is a schematic drawing of a linear mirror SCR 600 that is placed in a vertical configuration. Like numbered items are as described with respect to FIGS. 1 and 2. This is similar to the configuration of FIG. 4, except that a linear mirror 602 is placed in a vertical configuration. The linear mirror 602 may be inclined to follow the sun. The selection of the configuration may be based on the latitude of the plant.

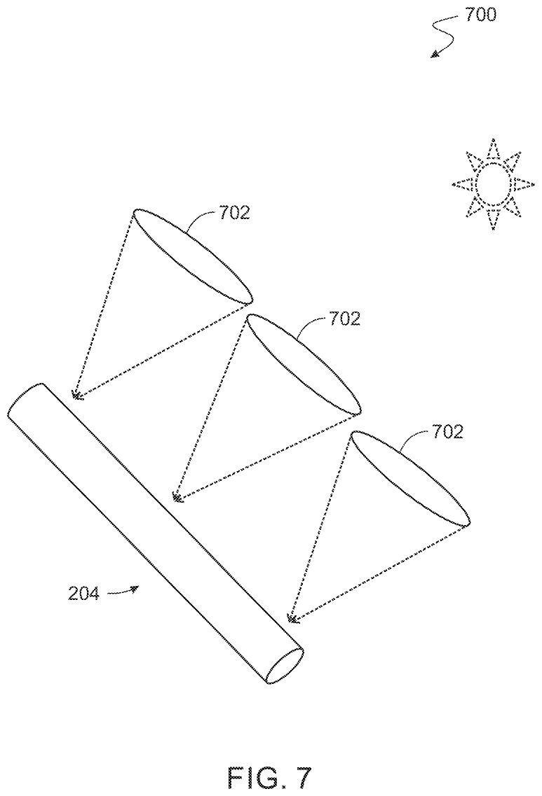

FIG. 7 is a schematic drawing of an optical concentrator SCR 700 for hydrogen production. Like numbered items are as described with respect to FIGS. 1 and 2. In this example, the solar concentrator 702 utilizes transmitted sunlight concentrator through a refractive optical element or an array of refractive optical elements instead of a reflective sunlight concentrator. For example, the refractive element can be a lens or lens array that is made out of an optically transparent material such as glass or a polymer, such as polycarbonate. The lens can be a focusing type such as a convex or planoconvex lens. Further, the lens can be a Fresnel type. Fresnel lenses can concentrate light with less material, hence can be light-weight and low cost. In some embodiments, a combination of transmitted and reflected sunlight devices are integrated to increase the efficiency of the heating.

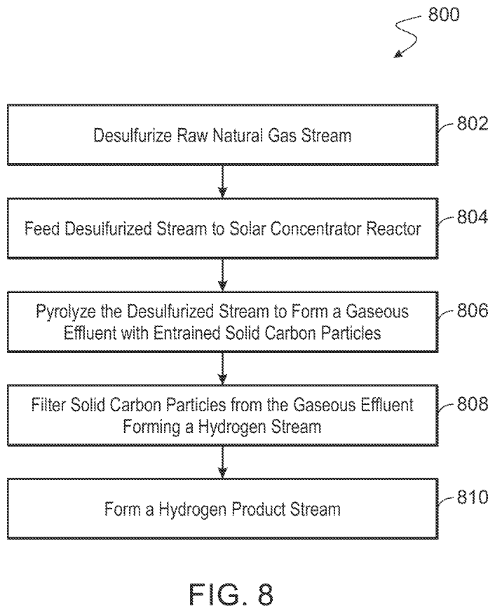

FIG. 8 is a block flow diagram of a method 800 for producing hydrogen from a natural gas stream using solar energy. The method 800 begins at block 802 with the desulfurization of a raw natural gas stream. The raw natural gas stream may be processed in a water oil separation plant (WOSP) or gas oil separation plant (GOSP), to remove water and heavier hydrocarbons, prior to being processed in the desulfurization.

At block 804, the desulfurized stream is fed to a solar concentrator reactor (SCR), as described herein. An inert gas, such as nitrogen or argon, can be added to the desulfurized stream to function as a carrier gas, helping to sweep solid carbon products out of the SCR.

At block 806, the desulfurized stream is pyrolyzed in the SCR to form a gaseous effluent with entrained solid carbon particles, formed from the pyrolysis of the methane. At block 808, the solid carbon particles are filtered from the gaseous effluent.

At block 810, a hydrogen product stream is formed from the gaseous effluent. This may be performed by running the gaseous effluent through a hydrogen separation membrane, wherein the hydrogen product is isolated as the permeate. The retentate, which may include unreacted methane, the carrier gas, and other impurities, may be recycled to the inlet of the SCR.

### Embodiments

An embodiment described herein provides a solar powered system for production of hydrogen from natural gas. The solar powered system includes a feed stream including methane and a solar concentrator reactor (SCR) to form hydrogen from the feed stream by pyrolysis. The SCR includes a rotating tubular reactor, a solar absorber material disposed on the rotating tubular reactor, a solar concentrator to focus sunlight on the rotating tubular reactor, and a gas-solid filtration unit to separate solid carbon from the hydrogen. The solar powered system includes a storage tank to hold the hydrogen.

In an aspect, combinable with any other aspect, the solar powered system includes a raw natural gas feed stream, and a desulfurization reactor to form the feed stream from the raw natural gas feed stream.

In an aspect, combinable with any other aspect, the rotating tubular reactor includes a stainless-steel tube.

In an aspect, combinable with any other aspect, the rotating tubular reactor includes a heat conductive ceramic.

In an aspect, the heat conductive ceramic includes aluminum nitride.

In an aspect, the heat conductive ceramic includes a composite of aluminum nitride and boron nitride.

In an aspect, combinable with any other aspect, the rotating tubular reactor includes a methane pyrolysis catalyst.

In an aspect, the methane pyrolysis catalyst includes Ni, Fe, Pd, or Mo, or any combination thereof.

In an aspect, the methane pyrolysis catalyst is supported on a catalyst support including Al₂O₃, Al₂O₄, SiO₂, MgO, TiO₂, Fe₂O₄, FeO, ZrO₂, CeO₂, Er₂O₃, or a lanthanide oxide, or any combination thereof.

In an aspect, combinable with any other aspect, the solar concentrator includes a parabolic reflector with the rotating tubular reactor disposed at a focal point.

In an aspect, the parabolic reflector is configured to track the sun.

In an aspect, combinable with any other aspect, the solar concentrator includes a linear solar concentrator.

In an aspect, the linear solar concentrator is configured to track the sun.

In an aspect, combinable with any other aspect, the solar concentrator includes an optical lens.

In an aspect, the optical lens is configured to track the sun.

In an aspect, the optical lens is a Fresnel lens.

In an aspect, combinable with any other aspect, the solar absorber material includes a two-layer coating, wherein an outer layer includes a coating that is substantially transparent to light in a wavelength range of about 250 nm to about 1500 nm, and an inner layer, disposed under the outer layer, includes a coating that is substantially opaque to light in a wavelength range of about 250 nm to about 1500 nm.

In an aspect, the outer layer includes glass, sapphire, or diamond, or a combination thereof.

In an aspect, the inner layer includes a solid film.

In an aspect, the solid film includes carbon black, or silicon carbide, or both.

In an aspect, the inner layer includes a meta-material.

In an aspect, the meta-material includes silicon carbide particles in a size range of about 10 nm to about 200 nm.

In an aspect, a layer includes a substrate for the silicon carbide particles.

In an aspect, combinable with any other aspect, the solid carbon includes carbon black.

In an aspect, combinable with any other aspect, the solid carbon includes carbon nanotubes.

Another embodiment described herein provides a method of producing hydrogen in a solar concentrator reactor. The method includes desulfurizing a raw natural gas stream to form a desulfurized stream, feeding the desulfurized stream to a solar concentrator reactor. The solar concentrator reactor includes a rotating tubular reactor, a solar absorber material disposed on the rotating tubular reactor, a solar concentrator to focus sunlight on the rotating tubular reactor, and a gas-solid filtration unit to separate solid carbon from the hydrogen. The method includes pyrolyzing the desulfurized stream to form a gaseous effluent including hydrogen and entrained solid carbon particles, separating solids from the hydrogen, and providing the hydrogen as a product stream.

In an aspect, combinable with any other aspect, dehydrating the raw natural gas stream.

In an aspect, combinable with any other aspect, the method includes rotating the solar concentrator to track the sun.

In an aspect, combinable with any other aspect, the method includes providing the solid carbon particles as a product stream.

Other implementations are also within the scope of the following claims.

What is claimed is:

1. A solar powered system for production of hydrogen from natural gas, comprising:
a feed stream comprising methane; and
a solar concentrator reactor (SCR) to form hydrogen from the feed stream by pyrolysis, comprising:
a rotating tubular reactor;
a solar absorber material disposed on the rotating tubular reactor;
a solar concentrator to focus sunlight on the rotating tubular reactor; and
a gas-solid filtration unit to separate solid carbon from the hydrogen; and
a storage tank to hold the hydrogen.

2. The system of claim 1, comprising:
a raw natural gas feed stream; and
a desulfurization reactor to form the feed stream from the raw natural gas feed stream.

3. The system of claim 1, wherein the rotating tubular reactor comprises a stainless-steel tube.

4. The system of claim 1, wherein the rotating tubular reactor comprises a heat conductive ceramic.

5. The system of claim 4, wherein the heat conductive ceramic comprises aluminum nitride.

6. The system of claim 4, wherein the heat conductive ceramic comprises a composite of aluminum nitride and boron nitride.

7. The system of claim 1, wherein the rotating tubular reactor comprises a methane pyrolysis catalyst.

8. The system of claim 7, wherein the methane pyrolysis catalyst comprises Ni, Fe, Pd, or Mo, or any combination thereof.

9. The system of claim 8, wherein the methane pyrolysis catalyst is supported on a catalyst support comprising Al₂O₃, Al₂O₄, SiO₂, MgO, TiO₂, Fe₂O₄, FeO, ZrO₂, CeO₂, Er₂O₃, or a lanthanide oxide, or any combination thereof.

10. The system of claim 1, wherein the solar concentrator comprises a parabolic reflector with the rotating tubular reactor disposed at a focal point.

11. The system of claim 10, wherein the parabolic reflector is configured to track the sun.

12. The system of claim 1, wherein the solar concentrator comprises a linear solar concentrator.

13. The system of claim 12, wherein the linear solar concentrator is configured to track the sun.

14. The system of claim 1, wherein the solar concentrator comprises an optical lens.

15. The system of claim 12, wherein the optical lens is configured to track the sun.

16. The system of claim 12, wherein the optical lens is a Fresnel lens.

17. The system of claim 1, wherein the solar absorber material comprises a two-layer coating, wherein an outer layer comprises a coating that is substantially transparent to light in a wavelength range of about 250 nm to about 1500 nm, and an inner layer, disposed under the outer layer, comprises a coating that is substantially opaque to light in a wavelength range of about 250 nm to about 1500 nm.

18. The system of claim 17, wherein the outer layer comprises glass, sapphire, or diamond, or a combination thereof.

19. The system of claim 17, wherein the inner layer comprises a solid film.

20. The system of claim 19, wherein the solid film comprises carbon black, or silicon carbide, or both.

21. The system of claim 17, wherein the inner layer comprises a meta-material.

22. The system of claim 21, wherein the meta-material comprises silicon carbide particles in a size range of about 10 nm to about 200 nm.

23. The system of claim 22, wherein a layer comprises a substrate for the silicon carbide particles.

24. The system of claim 1, wherein the solid carbon comprises carbon black.

25. The system of claim 1, wherein the solid carbon comprises carbon nanotubes.

26. A method of producing hydrogen in a solar concentrator reactor, comprising:
desulfurizing a raw natural gas stream to form a desulfurized stream;
feeding the desulfurized stream to a solar concentrator reactor, wherein the solar concentrator reactor comprises:
a rotating tubular reactor;
a solar absorber material disposed on the rotating tubular reactor;
a solar concentrator to focus sunlight on the rotating tubular reactor; and
a gas-solid filtration unit to separate solid carbon from the hydrogen;
pyrolyzing the desulfurized stream to form a gaseous effluent comprising hydrogen and entrained solid carbon particles;
separating solids from the hydrogen; and
providing the hydrogen as a product stream.

27. The method of claim 26, comprising dehydrating the raw natural gas stream.

28. The method of claim 26, comprising rotating the solar concentrator to track the sun.

29. The method of claim 26, comprising providing the solid carbon particles as a product stream.
